(19) United States
(12) Patent Application Publication
(10) Pub. No.: US 2026/0366985 A1
(43) Pub. Date: Nov. 19, 2026

(54) SYSTEM AND METHOD FOR CELL EXPANSION WITH FUNCTIONAL POPULATION CYTOMETRY

(71) Applicant: Ramona Optics Inc., Durham, NC (US)

(72) Inventors: Mark Harfouche, Durham, NC (US); Gregor Horstmeyer, Durham, NC (US); Aurélien Gauthier Florent Bègue, Durham, NC (US)

(73) Assignee: Ramona Optics Inc., Durham, NC (US)

(21) Appl. No.: 19/680,685

(22) Filed: May 18, 2026

Related U.S. Application Data
(60) Provisional application No. 63/806,818, filed on May 16, 2025.

(51) Int. Cl. G01N 15/1434; G01N 15/14

(52) U.S. Cl. CPC G01N 15/1434; G01N 15/14; G01N 2015/1402; G01N 2015/1445

(57) ABSTRACT

A system and method for cell expansion with functional population cytometry are disclosed. A multi-well vessel contains a heterogeneous population of viable biological entities, and a parallelized multi-camera array microscope acquires time-lapse image data across multiple partitions and planes of focus. An image analysis subsystem assigns unique identifiers to individual biological entities, tracks the entities over time, and computes longitudinal functional biomarker metrics such as motility, synapse formation, cytotoxicity, apoptosis, proliferation, netosis, or exhaustion. A spatial coordinate determination module applies user-defined selection criteria to identify entities of interest and determine their coordinates within the vessel. A retrieval apparatus, including a cell picker or electrically active substrate, selectively isolates living entities of interest while preserving viability. Retrieved entities may be expanded ex vivo into monoclonal or polyclonal populations for genomic, transcriptomic, proteomic, drug development, or adoptive cell therapy applications.

### CROSS-REFERENCE TO RELATED APPLICATIONS

This application claims the benefit under 35 U.S.C. § 119(e) of U.S. Provisional Patent Application No. 63/806,818, filed on May 16, 2025, entitled “SYSTEM AND METHOD FOR CELL EXPANSION WITH FUNCTIONAL POPULATION CYTOMETRY,” the entire contents of which are incorporated herein by reference.

### FIELD OF THE INVENTION

The present disclosure relates generally to cell analysis, microscopy, cytometry, cell culture, and cell manufacturing technologies and, more particularly, to systems and methods for non-destructively measuring longitudinal functional biomarkers of individual viable biological entities, identifying biological entities of interest from heterogeneous populations, selectively retrieving the identified biological entities while preserving viability, and expanding the retrieved biological entities for downstream use.

### BACKGROUND OF THE INVENTION

Cancer, viral infection, bacterial infection, autoimmune disease, and other pathologic conditions remain major causes of death, disability, and medical cost. In many such conditions, a small subset of cells within a heterogeneous biological population may have functional properties that are therapeutically or analytically valuable. For example, a small subset of endogenous immune cells may recognize, bind to, attack, or kill a target cell, such as a cancer cell or an infected cell, while most cells in the same population may not exhibit the same functional behavior.

Adoptive cell therapy has demonstrated that a patient's own immune cells can be used to treat disease. Examples include chimeric antigen receptor T cell therapy, tumor infiltrating lymphocyte therapy, and engineered T cell receptor therapy. These approaches have produced promising clinical outcomes, particularly in selected cancers, but they can involve high manufacturing costs, genetic engineering, complex patient-specific characterization, bulk expansion of heterogeneous cells, and toxic or burdensome treatment regimens. Such limitations are especially significant for solid tumors and for diseases in which the most useful endogenous cells are rare.

Tumor infiltrating lymphocyte therapy can exploit immune cells that already recognize patient-specific tumor antigens or neoantigens, but tumor-resident cells may be exhausted, difficult to obtain in sufficient numbers, and variable in quality from patient to patient. Engineered T cell receptor therapy can target tumor-associated antigens or neoantigens, but often requires prior identification and characterization of the relevant antigen targets. Other immune cell types, including natural killer cells, neutrophils, macrophages, B cells, and induced pluripotent stem cell-derived cells, are also being investigated for therapeutic and research applications, yet methods for selecting functionally useful cells from large heterogeneous populations remain limited.

Conventional cytometry and cell sorting systems can measure many cells rapidly, but they typically assess each cell at a single time point and often rely on fluorescent labels, staining, antibody binding, or other exogenous markers. These measurements may indicate phenotype, expression state, or morphology, but they do not necessarily reveal longitudinal functional behavior, such as motility, synapse formation, synapse duration, killing of target cells, proliferation, exhaustion, or other dynamic activities observed over time. Moreover, labels can introduce toxicity, alter cell behavior, or create confounding variables, particularly when viable cells are intended for therapeutic use.

Microscopy can observe dynamic cell behavior, including cell-cell interactions, but conventional microscopes are limited in throughput when used to image large populations over extended time periods. A single-objective microscope generally images only a small field of view at a time, making it difficult to monitor millions of individual cells across a vessel with sub-minute temporal resolution for multiple hours. Even when longitudinal image data are acquired, existing workflows do not adequately integrate single-cell functional analysis, spatial coordinate determination, and viable retrieval of selected cells for downstream expansion.

Accordingly, there is a need for systems and methods that can non-destructively monitor large heterogeneous populations of living biological entities with single-entity resolution, assign persistent identifiers to the biological entities, compute longitudinal functional biomarker metrics, apply multi-parameter selection criteria to identify entities of interest, determine the spatial coordinates of the selected entities, and selectively retrieve viable selected entities for downstream characterization, expansion, research, drug development, and personalized medicine.

### SUMMARY OF THE INVENTION

The present disclosure provides systems and methods for identifying, selecting, retrieving, and expanding viable biological entities of interest from a heterogeneous population. In one aspect, the system comprises a functional population cytometer, referred to herein as PopCy, configured to non-destructively measure longitudinal functional biomarkers of individual biological entities across large populations and to retain the ability to recover living biological entities that satisfy selected functional criteria.

In one embodiment, the system includes a multi-well or partitioned vessel configured to contain a population of biological entities distributed across a plurality of partitions, sub-partitions, wells, or open vessel regions. The vessel may be optically transparent and may conform to the Society for Biomolecular Sciences or ANSI-standard microplate exterior dimension format. The vessel may include an open footprint, a plurality of wells, sub-partitions within wells, or combinations thereof, and may support co-cultures of effector cells and target cells.

In another embodiment, the system includes a parallelized multi-camera array microscope comprising a plurality of imaging units arranged to simultaneously acquire time-lapse image data across more than one plane of focus and across multiple partitions of the vessel. The imaging units may operate synchronously to record spatiotemporal dynamics of individual biological entities at minute or sub-minute temporal resolution. In some embodiments, the microscope includes between 24 and 96 imaging units, and a mechanical stage is configured to traverse a plurality of XY positions so that the imaging units sequentially record from multiple partitions and acquire full-vessel image data at high temporal resolution.

In a further embodiment, an image analysis subsystem processes the time-lapse image data to assign a unique identifier to each individual biological entity, track each identified entity across a plurality of timepoints, and compute one or more quantitative functional biomarker metrics based on longitudinal behavior. The functional biomarker metrics may include motility, synapse formation, synapse duration, apoptosis, cytotoxicity, proliferation with lineage tracing, netosis, exhaustion, and other functional metrics. In some embodiments, at least one functional biomarker metric is derived from label-free image data without fluorescent stains, fluorescent transgenes, or exogenous optical labels.

In another aspect, a spatial coordinate determination module receives the functional biomarker metrics, applies one or more user-defined selection criteria, and determines spatial coordinates of biological entities of interest within the vessel. The selection criteria may comprise multi-parameter gates requiring a biological entity to satisfy threshold conditions across two or more functional biomarker metrics simultaneously.

In yet another aspect, a retrieval apparatus is operatively coupled to the spatial coordinate determination module and selectively isolates one or more living biological entities of interest from the vessel based on the determined spatial coordinates while preserving viability. In some embodiments, the retrieval apparatus includes a cell-picking device guided to the spatial coordinates of selected entities, and the multi-camera array microscope verifies the location of each entity during the retrieval operation. In other embodiments, the retrieval apparatus includes an electrically active substrate having addressable electrode sectors configured to generate localized electric fields to immobilize selected entities, displace non-selected entities, or move material within the vessel.

The electrically active substrate may include optically transparent electrodes, photoconductive material, or combinations thereof. A controlled illumination source may selectively activate regions of the photoconductive material to dynamically modulate localized electric fields and generate directed wave patterns within liquid culture media. In this manner, selected cells may be held in place, non-selected cells or debris may be swept away, and selected viable cells may be subsequently released and collected.

In some embodiments, the system includes an environmental control unit configured to maintain cell culture conditions, including temperature, humidity, and gas composition, during image acquisition. In other embodiments, the system further includes an expansion module configured to receive retrieved biological entities of interest and expand them ex vivo into monoclonal or polyclonal populations for downstream use. Downstream uses may include genomic characterization, transcriptomic characterization, proteomic characterization, drug development, target discovery, diagnostic analysis, and adoptive cell therapy.

The biological entities may include autologous cells derived from a human or animal subject, allogeneic cells, established cell lines, biobank-derived cells, induced pluripotent stem cell-derived cells, engineered cells, T cells, natural killer cells, neutrophils, macrophages, B cells, tumor infiltrating lymphocytes, and other cell types. In one personalized medicine workflow, patient-derived immune cells are selected based on functional biomarkers demonstrating their in vitro ability to attack patient-derived cancer cells, infected cells, bacteria, viruses, or other targets, and the selected cells are retrieved, expanded, and optionally returned to the same subject as a therapeutic product.

Advantageously, the disclosed systems and methods enable functional population cytometry based on longitudinal behavior rather than only single-timepoint phenotype. The systems and methods can identify rare functionally useful living cells within large heterogeneous populations, retrieve those cells while preserving viability, and generate expanded populations suitable for research, drug development, personalized medicine, or cellular therapy.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF DRAWINGS

Having thus described the subject matter of the present invention in general terms, reference will now be made to the accompanying drawings, which are not necessarily drawn to scale, and wherein:

FIG. 1 illustrates a flow chart of an example functional population cytometry workflow in which biological entities are obtained, longitudinal functional biomarkers are measured, entities of interest are selected and retrieved while viable, and the retrieved entities are expanded, characterized, or used downstream;

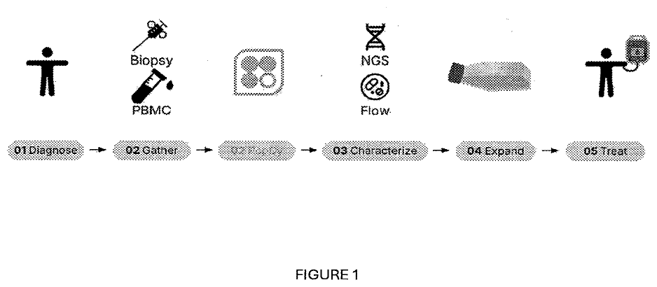

FIG. 2 illustrates a schematic embodiment of a PopCy system including an optically transparent vessel, an environmental control unit, a parallelized multi-camera array microscope, an image analysis subsystem, a spatial coordinate determination module, a retrieval apparatus, and an expansion module;

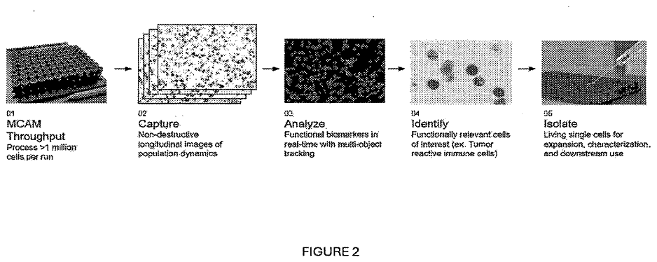

FIG. 3 illustrates an example vessel having an open footprint, wells, partitions, or sub-partitions arranged within a standard microplate footprint for holding co-cultures of effector cells and target cells;

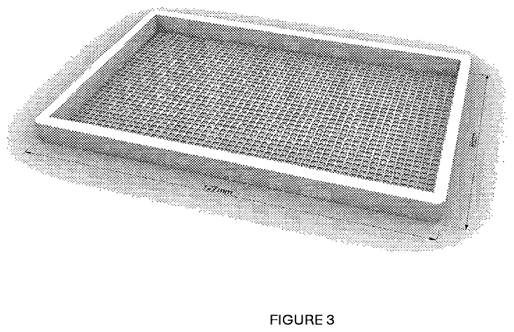

FIG. 4 illustrates assignment of unique identifiers to individual biological entities and longitudinal tracking of the identified biological entities across multiple timepoints;

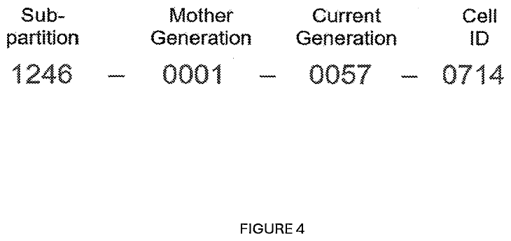

FIG. 5 illustrates label-free image data and associated quantitative functional biomarker metrics derived from longitudinal observation of biological entities, including one or more of motility, synapse formation, apoptosis, cytotoxicity, proliferation, netosis, and exhaustion; and

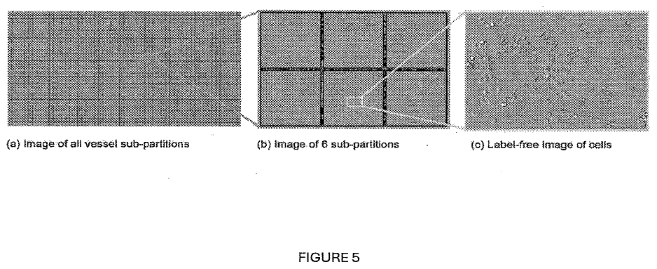

FIG. 6 illustrates an electrically active substrate having addressable electrode sectors and/or photoconductive regions configured to generate localized electric fields for immobilizing selected biological entities, displacing non-selected biological entities, or otherwise assisting retrieval.

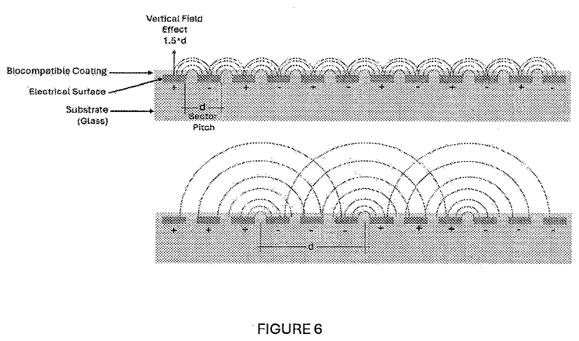

FIG. 7 illustrates an example embodiment of the proposed system for imaging, immobilizing selected biological entities, and selecting biological material of interest. Microscope array and illumination used to image biological material in multiwell plate. First processor and computer used to process time-laps images to identify cellular material of interest. Transparent electrodes used to immobilizing selected biological entities. Glass pipette or other type of cell selector used to extract target cells of interest from multi-well plate for downstream use.

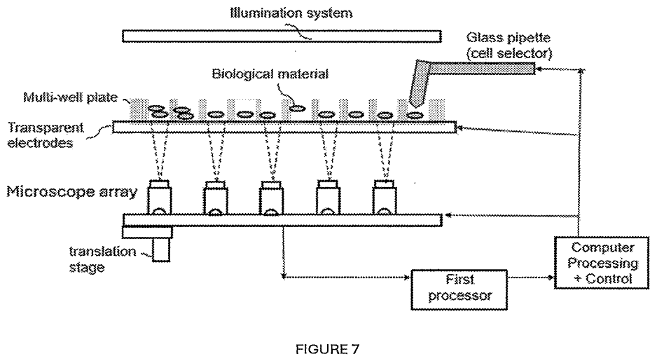

FIG. 8 illustrates an example embodiment of 3-step process for identifying, immobilizing, and selecting biological entities of interest. Live cellular and/or biological material is first microscopically imaged over time and digitally tracked via a microscope array. Software is used to identify target cells for selection based on morphology and behavior. Electrode sectors and/or photoconductive regions configured to generate localized electric fields are then used to apply an electric field to immobilizing selected biological entities. Finally, cell selector tools are used to select and remove target cells from the multiwell plate.

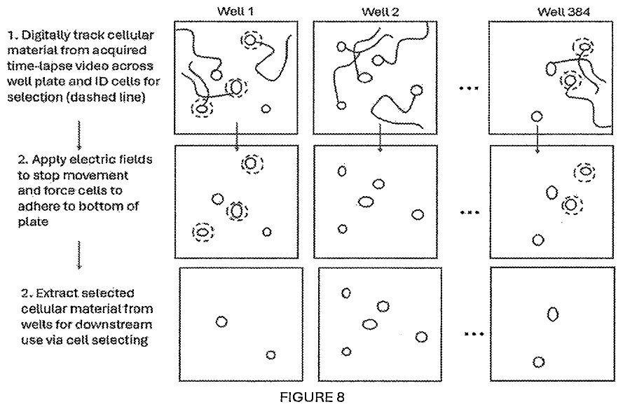

### DETAILED DESCRIPTION OF THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

As described more fully below, the present disclosure is directed to a system and method for cell expansion with functional population cytometry. The system non-destructively records living biological entities over time, generates quantitative functional biomarker metrics for individual entities, identifies viable entities of interest based on one or more functional gates, retrieves selected entities using spatial coordinates, and supports expansion and downstream use of the retrieved entities.

### Overview of Functional Population Cytometry

The PopCy system is a general purpose tool for identifying functionally useful biological entities and collecting them while they remain living and viable. Unlike traditional flow cytometry, which typically measures each cell at a single time point, PopCy measures longitudinal behavior of individual biological entities across time and space. Such longitudinal behavior can reveal functional properties that cannot be reliably inferred from a single static measurement.

In one embodiment, the system is used to identify immune cells that attack target cells. The target cells may be cancer cells, virally infected cells, bacterially infected cells, bacteria, or other target biological materials. The immune cells may be T cells, natural killer cells, neutrophils, macrophages, B cells, tumor infiltrating lymphocytes, or other immune cells. In other embodiments, the biological entities of interest may be non-immune cells, induced pluripotent stem cell-derived cells, engineered cells, or any biological entities whose function can be observed over time and whose viable recovery is desired.

The system may be used in basic research, drug development, target discovery, diagnostics, personalized medicine, and cell manufacturing. For example, viable cells selected by PopCy may be expanded into monoclonal populations, combined into polyclonal populations, characterized using genomic, transcriptomic, proteomic, or other multi-omic techniques, or prepared for use as adoptive cellular therapy products.

### System Architecture

In one embodiment, the PopCy tool comprises an optically transparent vessel to hold cells or other biological entities, an environmental control unit to maintain cell culture conditions, a specialized optical video microscope to non-destructively record the biological entities with single-entity resolution, automated analysis software to process video microscopy data and generate metrics for each individual entity, a spatial coordinate determination module, and a retrieval apparatus to extract and retain viable biological entities of interest for downstream use.

The components may be operatively coupled through one or more processors, controllers, data storage devices, motor controllers, fluidic controllers, electrical driving circuits, and user interfaces. The system may operate continuously during an assay so that image acquisition, image processing, biomarker computation, selection, coordinate determination, and retrieval planning occur in real time or near real time.

In some embodiments, the system further includes an expansion module that receives selected biological entities and maintains culture conditions suitable for clonal or polyclonal expansion. The expansion module may include one or more vessels, incubators, perfusion systems, culture media reservoirs, cytokine or activating factor delivery systems, sensors, and automated or semi-automated handling devices.

### Input Cells and Assay Preparation

Input cells may be autologous cells obtained from a subject or allogeneic cells obtained from a donor, established cell line, biobank, induced pluripotent stem cell source, or engineered cell population. In the context of human or animal care, the term subject may refer to a human patient or an animal patient. In research and drug development contexts, the input biological entities may be derived from model organisms, engineered cell lines, or other sources.

In one embodiment for adoptive cell therapy for cancer treatment, a tumor biopsy or fine needle aspirate and a blood sample are obtained from a subject. The tumor biopsy may be mechanically and/or enzymatically dissociated, and cancer cells may be isolated using established cell culture methods, bulk separation techniques, or combinations thereof. White blood cells may be extracted from peripheral blood through leukapheresis or other collection techniques, and T cells or other immune cell subsets may be isolated from the bulk leukocyte population using magnetic bead separation, affinity separation, flow sorting, or other established techniques.

Effector cells and target cells may be deposited into the vessel as a co-culture. Various target-to-effector ratios may be used depending on the assay design. In one illustrative embodiment, a target-to-effector ratio of 1:10 is used, with approximately 100 target cells and approximately 1,000 effector cells per sub-partition. Cell culture media, cytokines, activating factors, interleukins, growth factors, antibodies, antigen-presenting components, or other assay reagents may be added to the vessel before, during, or after imaging.

### Multi-Well Vessel and Partitions

The vessel may be optically transparent at least in regions through which image data are acquired. The vessel may be an open footprint vessel similar to a rectangular petri dish, may be partitioned into a plurality of wells, may include sub-partitions within each main well, or may include combinations thereof. The vessel may be configured to constrain or localize cells while allowing optical access, media exchange, retrieval access, and environmental control.

In one embodiment, the exterior dimensions of the vessel measure approximately 127.76 mm in length and approximately 85.48 mm in width, conforming to the Society for Biomolecular Sciences standard microplate footprint. The height of the vessel may vary and may be, for example, in the range of approximately 8 mm to approximately 14 mm. The vessel may include 12, 24, 48, 96, 384, 1536, or other numbers of wells or sub-partitions.

In an illustrative example, an open vessel includes 1536 sub-partitions. A mixture of cancer cells as target cells and T cells as effector cells is seeded into the vessel. At a density of approximately 100 target cells and approximately 1,000 effector cells per sub-partition, the vessel may contain roughly 150,000 target cells and roughly 1.5 million effector cells. Other densities, ratios, vessel formats, and cell types may be used without departing from the scope of the disclosure.

### Environmental Control

The environmental control unit may maintain conditions suitable for viable cell culture during imaging and analysis. Such conditions may include temperature, humidity, carbon dioxide concentration, oxygen concentration, pH, osmolarity, media composition, evaporation control, sterility, and other parameters that affect cell viability or function.

The environmental control unit may include an incubated chamber within the PopCy tool. The vessel may be placed inside the chamber during imaging. One or more sensors may monitor environmental conditions, and one or more controllers may regulate heaters, humidifiers, gas supplies, fans, valves, pumps, or other components to maintain the desired culture environment over multiple hours or days of imaging.

### Parallelized Multi-Camera Array Microscope

The PopCy tool includes a specialized optical video microscope that may comprise an array of individual image sensors, optical focusing elements, and illumination sources that operate synchronously in a parallelized manner. In one embodiment, the microscope comprises a multi-camera array microscope having 24, 48, 96, or another number of parallelized micro-cameras that operate simultaneously within the footprint of the vessel.

Each imaging unit may include a CMOS image sensor, an imaging lens system, one or more focusing elements, and one or more illumination sources. The imaging units may acquire image data across more than one plane of focus, which may be achieved through mechanical focusing, optical focusing, axial scanning, computational refocusing, multiple acquired images at different focus settings, or combinations thereof. The imaging units may acquire bright-field, phase, dark-field, fluorescence, multispectral, or other image data depending on the optical configuration.

In an embodiment using 24 micro-cameras with a vessel having 1536 sub-partitions, 24 sub-partitions may be recorded simultaneously. A mechanical stage may move the vessel, the microscope, or both to visit 64 XY positions so that each micro-camera records from multiple sub-partitions. At each location, integrated illumination sources may be used to capture one or more images. Multiple images may be combined to optimize focus or sharpness, increase contrast, obtain multiple planes of focus, or capture spectral information using optical filters.

Using such a configuration, the system may capture image data from all 1536 sub-partitions at minute or sub-minute temporal resolution. For example, if approximately one second is used per stage location across 64 locations, a complete vessel may be sampled in approximately 64 seconds. The acquisition process may be repeated across many timepoints for multiple hours, thereby generating a longitudinal dataset for each partition or sub-partition.

### Longitudinal Imaging and Data Management

The PopCy tool may record time-lapse image data at minute or sub-minute timescales for hours or longer across more than one million biological entities. At these timescales, activities of immune cells, target cells, and other biological entities can be recorded and analyzed to identify entities that exhibit desired behavior. For example, T cells may be monitored to identify cells that form synapses with cancer cells and subsequently induce target-cell death.

The system may operate at high data rates. Raw image capture rates may reach multiple gigabits per second at moderate temporal resolutions and may exceed 100 gigabits per second at higher temporal sampling. Accordingly, the system may include local or edge computational resources configured to compress video, encode relevant image features, reduce raw image data volume, and generate tabular functional biomarker metrics in real time or near real time.

In some embodiments, in-line computation reduces raw image data into manageable volumes of encoded video and tabular metrics. Data analysis running concurrently with acquisition enables quantitative decision-making during the assay and may allow selection and retrieval to begin during the evaluation or immediately after completion of a prescribed co-culture evaluation period.

### Image Analysis and Functional Biomarker Determination

The image analysis subsystem may process the time-lapse image data to identify individual biological entities, assign a unique identifier to each entity, and track each entity across a plurality of timepoints. Tracking may include segmentation, object detection, feature extraction, motion estimation, probabilistic association, lineage tracking, and correction of track merges or splits. The image analysis subsystem may employ traditional image-processing algorithms, deep learning algorithms, or combinations thereof.

Functional biomarker metrics may be computed for each tracked biological entity. Such metrics may include motility, movement distance, movement speed, movement directionality, persistence, synapse formation, proximity to target cells, synapse duration, target-cell apoptosis, effector-cell apoptosis, cytotoxicity, proliferation, lineage tracing, netosis, exhaustion, changes in morphology, changes in optical density, and other metrics derived from longitudinal image data.

In one example, cytotoxicity may be quantified as a value that increases when a tracked immune cell forms a synapse with a target cell and the target cell subsequently dies. At the beginning of an evaluation, each T cell may have a cytotoxicity metric of zero, and as individual T cells attack and kill cancer cells, the cytotoxicity metric for the attacking T cells may increase with each target cell killed. Similar longitudinal metrics may be defined for proliferation, motility, persistence of interaction, exhaustion, or other functional behaviors.

At least some functional biomarker metrics may be derived from label-free image data without fluorescent stains, fluorescent transgenes, or exogenous optical labels. Label-free operation may avoid toxicity, perturbation of cell behavior, or confounding effects of optical labels, which can be important when selected cells are intended for therapeutic use. In other embodiments, cells expressing fluorescent transgenes, cells prepared with fluorescent stains, or cells labeled with optical probes may be used, particularly for basic research, pre-clinical development, or assays in which labeling is acceptable.

### Functional Gating and Spatial Coordinate Determination

The PopCy system may operate in a manner analogous to cytometric gating, except that the gate inputs may include longitudinal functional metrics rather than only single-timepoint measurements. During or after an assay, individual biological entities may be evaluated across multiple functional biomarker gates. For example, selected T cells may be required to have a cytotoxicity score greater than a threshold, a motility score greater than a threshold, and a proliferation score greater than a threshold.

The spatial coordinate determination module may receive functional biomarker metrics from the image analysis subsystem, apply one or more user-defined selection criteria, and identify biological entities of interest. The module may determine the spatial coordinates of each selected entity within the vessel. Coordinates may include vessel identifier, well identifier, partition identifier, sub-partition identifier, camera identifier, stage position, image coordinates, and optionally an axial or focus coordinate.

The determined spatial coordinates may be used to guide a retrieval apparatus. In some embodiments, the multi-camera array microscope verifies the position of each selected entity immediately before or during retrieval. Verification may account for cell motility, stage motion, media flow, drift, or other changes between selection and retrieval.

### Cell Retrieval Apparatus

In one embodiment, the retrieval apparatus comprises a cell-picking device configured to be guided to the spatial coordinates of selected biological entities. The cell-picking device may include a pulled-glass pipette, micropipette, capillary, microfluidic probe, suction probe, nozzle, robotic manipulator, or other device configured to isolate one or more viable cells from a partition or sub-partition. Retrieved cells may be placed in a separate vessel, such as a 96-well plate or another culture vessel, for further processing.

The retrieval apparatus may be controlled automatically or semi-automatically based on the coordinates determined by the spatial coordinate determination module. The multi-camera array microscope may monitor and verify the selected entity before retrieval, during aspiration or isolation, and after retrieval to confirm successful removal and preserve an image-based record of the operation.

The retrieval apparatus may retrieve individual cells, groups of cells, interacting cell pairs, cell clusters, colonies, or other biological entities. In certain embodiments, the system retrieves hundreds to thousands of useful cells that satisfy functional selection criteria, rather than relying on the expansion of a single selected cell.

### Electrically Active Substrate Retrieval

In another embodiment, the retrieval apparatus comprises an electrically active substrate disposed on a surface of the vessel. The electrically active substrate may include a plurality of addressable electrode sectors configured to generate localized electric fields. The electric fields may be controlled to immobilize one or more biological entities of interest at defined spatial coordinates, displace non-selected biological entities away from the entities of interest, or move cells or debris within liquid culture media.

The electrode sectors may be fabricated from an optically transparent material, such as indium tin oxide, so that the multi-camera array microscope retains optical access to the biological entities through the substrate. In one embodiment, the fields are arranged so that partitions or sub-partitions are segmented into many small sectors. A sector may be approximately 10 micrometers on a side, or may be larger or smaller depending on the cell type, vessel geometry, and desired spatial control. Field strength and field extent may be controlled in X, Y, and Z dimensions.

In some embodiments, selected cells are immobilized or frozen in place using localized electric fields before a cell-picking operation, before movement of the vessel, or during washing. This can reduce displacement of motile cells, stabilize selected cells for retrieval, and improve accuracy of cell isolation.

### Dynamic Electric Field and Photoconductive Embodiments

The electrically active substrate may further include photoconductive material. A controlled illumination source, such as a laser, digital light projector, thin-film transistor display, light emitting diode array, or other patterned illumination device, may selectively activate regions of the photoconductive material to modulate localized electric fields. By sequencing the illumination pattern over time, dynamic electrical fields or wave patterns may be generated in the liquid culture media.

Dynamic electrical addressing may be used to hold selected cells in place while non-selected cells, debris, or other material are swept or displaced to another region of the vessel. Non-selected content may also be removed with flowing liquid while selected cells remain immobilized. After the undesired content is removed, the selected cells may be released by removing or changing the local electric field and then transferred to another location or vessel by fluidic washing, pipetting, or other means.

In some embodiments, additives may be used to increase fluid density, conductivity, or viscosity within the partitions or sub-partitions. Additives may also be associated with the cells themselves. For example, small magnetic beads may be engulfed by cells or bound to cell surfaces to assist movement or isolation directed by dynamic control of the electrically active substrate. Such additives may be used to pre-position cells, minimize cell displacement during picking, or assist in the cell isolation and selection process.

### Expansion and Downstream Characterization

Once selected viable biological entities are isolated, the entities may be expanded ex vivo. The isolated entities may be expanded as monoclonal populations, polyclonal populations, or combinations thereof. For example, functionally validated tumor-reactive T cells may be expanded into multiple monoclonal colonies or combined into a polyclonal cell mixture. Depending on the number of doublings achieved, the expanded cells may be sufficient for characterization, research, drug development, or therapeutic administration.

Aliquots of expanded populations may be used for downstream characterization, including genomic, transcriptomic, proteomic, epigenomic, metabolomic, single-cell sequencing, flow cytometry, cytotoxicity assays, antigen specificity assays, receptor sequencing, and other analyses. The multi-omic data of functionally validated cells may be used for diagnostic purposes, target discovery, drug development, or process optimization.

In personalized medicine embodiments, the selected and expanded cells may be returned to the same subject as a therapeutic product. For example, endogenous functionally active immune cells selected based on their ability to attack patient-derived cancer cells may be expanded and infused into the subject to combat cancer. Similar workflows may be used to combat viral infection, bacterial infection, infected cells, or other targets.

### Additional Applications and Cell Types

Although certain examples herein refer to T cells and cancer cells, the system is not limited to such examples. The PopCy tool may be adapted for treatments and research in which large numbers of cells or other biological entities are evaluated, the effect of a cell on a target or the effect of a substance on a cell is determined, and selected cells or their contents are isolated and recovered.

The system may be used for cancer, drug-resistant bacterial infections, viral infections, autoimmune disease, inflammatory disease, regenerative medicine, vaccine development, cellular immunotherapy development, immune repertoire discovery, toxicity testing, screening of engineered cells, and other applications. Input cells may be autologous or allogeneic and may originate from human blood, tissue, tumors, cell lines, biobanks, induced pluripotent stem cells, or engineered populations.

In one embodiment, the system identifies tumor-antigen associated and neoantigen-specific T cells present in human peripheral blood at low concentrations. In another embodiment, the system identifies cells that attack unwanted viruses, bacteria, infected cells, or autoimmune targets. In still other embodiments, the system identifies proliferative, resilient, non-exhausted, or otherwise functionally desirable cells for expansion or analysis.

### General Definitions

It will be appreciated that various aspects of the disclosure may be embodied as a method, system, computer readable medium, and/or computer program product. Aspects of the disclosure may take the form of hardware embodiments, software embodiments, including firmware, resident software, micro-code, or the like, or embodiments combining software and hardware aspects that may all generally be referred to herein as a circuit, module, or system. Furthermore, the methods of the disclosure may take the form of a computer program product on a computer-usable storage medium having computer-usable program code embodied in the medium.

Any suitable computer usable medium may be utilized for software aspects of the disclosure. The computer-usable or computer-readable medium may be, for example but not limited to, an electronic, magnetic, optical, electromagnetic, infrared, or semiconductor system, apparatus, device, or propagation medium. The computer-readable medium may include transitory and/or non-transitory embodiments. More specific embodiments of the computer-readable medium would include some or all of the following: an electrical connection having one or more wires, a portable computer diskette, a hard disk, a random access memory, a read-only memory, an erasable programmable read-only memory or flash memory, an optical fiber, a portable compact disc read-only memory, an optical storage device, a transmission medium such as those supporting the Internet or an intranet, or a magnetic storage device.

Program code for carrying out operations of the disclosure may be written in an object-oriented programming language, a procedural programming language, a scripting language, a machine learning framework, or another programming environment. The program code may be executed by a processor, application specific integrated circuit, field-programmable gate array, graphics processing unit, neural processing unit, or other component that executes the program code. The program code may cause the processor or any processor-controlled device to acquire image data, analyze image data, generate functional biomarker metrics, determine spatial coordinates, control retrieval devices, control environmental conditions, or produce a graphical user interface.

The program code may locally and/or remotely execute. For example, the program code may be entirely or partially stored in local memory of the processor-controlled device, may be at least partially remotely stored, accessed, and downloaded to the processor-controlled device, or may be executed in a distributed computing environment. A user computer may entirely execute the program code, partly execute the program code, or coordinate execution of the program code on a remote computer or server. In the latter scenario, the remote computer may be connected to the user computer through a communications network.

The disclosure may be applied regardless of networking environment. The communications network may include the Internet, an intranet, a local-area network, a wide-area network, a distributed computing network, a wired network, a wireless network, a cellular network, a fiber optic network, or combinations thereof. Wireless communication interfaces may include, but are not limited to, Bluetooth technology, Wi-Fi, Wi-Max, IEEE 802.11 technology, radio frequency communication, infrared communication, Zigbee, Near-Field Communication, LiFi, 5G, and other types of wireless networking protocols.

Certain aspects of the disclosure are described with reference to various methods and method steps. It will be understood that each method step can be implemented by program code, machine instructions, dedicated hardware, or combinations thereof. The program code and/or machine instructions may create means for implementing the functions or acts specified in the methods. The program code may also be stored in a computer-readable memory that can direct a processor, computer, or other programmable data processing apparatus to function in a particular manner.

Any of a variety of light sources may be used to provide imaging light, illumination light, excitation light, patterned light, or controlled illumination for photoconductive components, including but not limited to tungsten lamps, tungsten-halogen lamps, arc lamps, lasers, laser diodes, light emitting diodes, vertical cavity surface emitting lasers, micro light emitting diode arrays, projectors, spatial light modulators, and display panels.

Terms and phrases used in this document, and variations thereof, unless otherwise expressly stated, should be construed as open ended as opposed to limiting. As examples of the foregoing, the term including should be read as meaning including without limitation or the like; the term example is used to provide exemplary instances of the item in discussion, not an exhaustive or limiting list thereof; and adjectives such as conventional, traditional, standard, known, and terms of similar meaning should not be construed as limiting the item described to a given time period or to an item available as of a given time, but instead should be read to encompass technologies that may be available or known now or at any time in the future.

Likewise, a group of items linked with the conjunction and should not be read as requiring that each and every one of those items be present in the grouping, but rather should be read as and/or unless expressly stated otherwise. Similarly, a group of items linked with the conjunction or should not be read as requiring mutual exclusivity among that group, but rather should also be read as and/or unless expressly stated otherwise. Furthermore, although items, elements, or components of the disclosure may be described or claimed in the singular, the plural is contemplated to be within the scope thereof unless limitation to the singular is explicitly stated.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims are to be understood as being modified in all instances by the term about even though the term about may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error, and other factors known to those of skill in the art.

Further, the term about when used in connection with one or more numbers or numerical ranges should be understood to refer to all such numbers, including all numbers in a range, and modifies that range by extending the boundaries above and below the numerical values set forth. The recitation of numerical ranges by endpoints includes all numbers, including whole integers and fractions thereof, subsumed within that range and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references may be referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

The foregoing description and accompanying figures illustrate the principles, embodiments, and modes of operation of the disclosure. However, the disclosure should not be construed as being limited to the particular embodiments discussed above. Additional variations of the embodiments discussed above will be appreciated by those skilled in the art. Therefore, the above-described embodiments should be regarded as illustrative rather than restrictive. Accordingly, it should be appreciated that variations to those embodiments can be made by those skilled in the art without departing from the scope of the disclosure as defined by the following claims.

1. A system for identifying and retrieving viable biological entities of interest from a heterogeneous population, the system comprising:
(a) a multi-well vessel configured to contain a population of biological entities distributed across a plurality of partitions;
(b) a parallelized multi-camera array microscope comprising a plurality of imaging units arranged to simultaneously acquire time-lapse image data across more than one plane of focus and across multiple partitions of the multi-well vessel, wherein the imaging units operate synchronously to record spatiotemporal dynamics of individual biological entities across the vessel at sub-minute temporal resolution;
(c) an image analysis subsystem operatively coupled to the multi-camera array microscope and configured to process the time-lapse image data to: (i) assign a unique identifier to each individual biological entity; (ii) track each identified biological entity across a plurality of timepoints; and (iii) compute one or more quantitative functional biomarker metrics for each tracked biological entity based on its longitudinal behavior;
(d) a spatial coordinate determination module configured to receive the functional biomarker metrics from the image analysis subsystem, apply one or more user-defined selection criteria to identify biological entities of interest, and determine the spatial coordinates of each identified biological entity of interest within the vessel; and
(e) a retrieval apparatus operatively coupled to the spatial coordinate determination module and configured to selectively isolate one or more living biological entities of interest from the vessel based on the determined spatial coordinates, while preserving viability of the retrieved entities for downstream use.

2. The system of claim 1, wherein the multi-camera array microscope comprises between 24 and 96 imaging units, each imaging unit comprising a CMOS image sensor, an imaging lens system and one or more illumination sources, wherein all imaging units are driven by one or more optical focusing elements, wherein all imaging units operate synchronously within the footprint of the multi-well vessel.

3. The system of claim 2, wherein the multi-camera array microscope further comprises a mechanical stage configured to traverse a plurality of XY positions such that each imaging unit sequentially records from a plurality of partitions, enabling full-vessel image data acquisition across all partitions at sub-minute temporal resolution.

4. The system of claim 1, wherein the multi-well vessel conforms to the Society for Biomolecular Sciences ANSI-standard microplate exterior dimension format and comprises one or more of: an open footprint vessel, a vessel partitioned into a plurality of wells, and a vessel having sub-partitions within each well, or any combination thereof.

5. The system of claim 1, wherein the image analysis subsystem is further configured to operate in real-time concurrently with data acquisition by the multi-camera array microscope, and wherein the image analysis subsystem employs one or both of traditional image-processing algorithms and deep learning algorithms to perform multi-object tracking across more than one million individual biological entities simultaneously.

6. The system of claim 1, wherein the one or more quantitative functional biomarker metrics comprise one or more of: motility, synapse formation, synapse duration, apoptosis, cytotoxicity, proliferation with lineage tracing, netosis, and exhaustion.

7. The system of claim 6, wherein at least one functional biomarker metric is derived from label-free image data without the use of fluorescent stains, fluorescent transgenes, or exogenous optical labels.

8. The system of claim 1, wherein the selection criteria applied by the spatial coordinate determination module comprise a multi-parameter gate requiring each biological entity of interest to satisfy threshold conditions across two or more functional biomarker metrics simultaneously.

9. The system of claim 1, wherein the retrieval apparatus comprises a cell-picking device configured to be guided to the spatial coordinates of each biological entity of interest as determined by the spatial coordinate determination module, and wherein the multi-camera array microscope is further used to verify the location of each biological entity of interest during the retrieval operation.

10. The system of claim 1, wherein the retrieval apparatus comprises an electrically active substrate disposed on a surface of the multi-well vessel, the electrically active substrate comprising a plurality of addressable electrode sectors configured to generate localized electric fields, wherein the electric fields are controllable to: (i) immobilize one or more biological entities of interest at defined spatial coordinates; and (ii) displace non-selected biological entities away from the biological entities of interest.

11. The system of claim 10, wherein the electrodes of the electrically active substrate are fabricated from an optically transparent material such that the multi-camera array microscope retains optical access to the biological entities through the substrate.

12. The system of claim 10, wherein the electrically active substrate further comprises photoconductive material, and wherein the system further comprises a controlled illumination source configured to selectively activate regions of the photoconductive material to dynamically modulate the localized electric fields, thereby generating directed wave patterns within liquid culture media in the vessel to sweep non-selected biological entities to defined locations within the vessel.

13. The system of claim 1, wherein the multi-well vessel is configured to support a co-culture of effector cells and target cells within each partition or sub-partition, and wherein the functional biomarker metrics are derived from longitudinal observation of interactions between the effector cells and the target cells.

14. The system of claim 13, wherein the effector cells are immune cells derived from peripheral blood mononuclear cells of a subject, and wherein the target cells are cancer cells derived from a tumor biopsy of the same subject.

15. The system of claim 14, wherein the immune cells comprise T cells, and wherein the functional biomarker metrics used as selection criteria include cytotoxicity, reflecting the number of target cancer cells killed following synapse formation with an individual T cell.

16. The system of claim 1, further comprising an environmental control unit configured to maintain one or more cell culture conditions within the multi-well vessel during image acquisition, the conditions including one or more of: temperature, humidity, and gas composition.

17. The system of claim 1, further comprising an expansion module configured to receive the retrieved biological entities of interest and expand them ex vivo into monoclonal or polyclonal populations for downstream use, wherein the downstream use comprises one or more of: genomic characterization, transcriptomic characterization, proteomic characterization, drug development, and adoptive cell therapy.

18. The system of claim 1, wherein the biological entities of interest are autologous cells derived from a human subject, and wherein the system is configured for use in a personalized medicine workflow in which the retrieved and expanded cells are returned to the same subject as a therapeutic product.

19. The system of claim 1, wherein the biological entities comprise one or more of: T cells, natural killer cells, neutrophils, macrophages, B cells, tumor infiltrating lymphocytes, and induced pluripotent stem cell-derived cells.

20. The system of claim 1, wherein the input cells are allogeneic and originate from one or more of: an established cell line, a biobank, induced pluripotent stem cells, or an engineered cell population.
